(19) United States
(12) Patent Application Publication
(10) Pub. No.: US 2005/0092207 A1
(43) Pub. Date: May 5, 2005

(54) Use of fatty acid esters based on fatty acids containing aromatic structural elements as solvents for printing inks

(76) Inventors: Rainer Hoefer, Duesseldorf (DE); Matthias Fies, Krefeld (DE); Alfred Westfechtel, Hilden (DE); Shailesh Shah, Dresher, PA (US)

Correspondence Address: COGNIS CORPORATION;PATENT DEPARTMENT, 300 BROOKSIDE AVENUE, AMBLER, PA, 19002, US

(21) Appl. No.: 10/946,202

(22) Filed: Sep. 21, 2004

Related U.S. Application Data
(60) Provisional application No. 60/507,784, filed on Oct. 1, 2003.

(51) Int. Cl. C09D 11/00; C08K 3/00

(52) U.S. Cl. 106/311; 106/31.35; 106/31.67

(57) ABSTRACT

Fatty acid esters of which the fatty acid constituents are saturated and/or mono- or polyolefinically unsaturated fatty acids containing a total of 12 to 22 carbon atoms and of which the alcohol constituents are saturated and/or mono- or polyolefinically unsaturated monoalcohols containing a total of 1 to 22 carbon atoms, with the additional proviso that the fatty acid constituents of the esters contain an aryl group which may optionally be substituted by an aliphatic group, are suitable as solvents for printing inks.

### CROSS-REFERENCE TO RELATED APPLICATIONS

This application claims benefit of priority, under 35 U.S.C. §119(e), of U.S. Provisional Patent Application No. 60/507,784, filed Oct. 1, 2003, the entire contents of which are herein incorporated by reference.

### FIELD OF THE INVENTION

This invention relates to the use of special fatty acid esters based on fatty acids containing aromatic structural elements as solvents for printing inks.

### PRIOR ART

Various printing processes are used to produce various types of printed products and may be divided into three main categories:
letterpress printing
planographic printing (or even offset printing) and
gravure printing.

In letterpress printing, the printing ink is transferred to the substrates from hard raised letters which are covered with a thin layer of ink by rubber rollers. The printing ink has to be formulated in such a way that it dries relatively slowly and does not begin to harden prematurely. Viscous slow-drying printing inks are required for modern high-speed newspaper printing machines using the rotary letterpress process.

In offset printing, the image to be reproduced is fixed on printing plates in the form of zones of opposite polarity. The hydrophobic viscous printing ink only wets the hydrophobic areas of the printing plates.

In gravure printing, the motif is engraved into the printing plate. After the printing plate has been wetted with the relatively low-viscosity printing ink, the surface is stripped so that printing ink is only left in the engraved depressions from which it is then transferred to the substrate to be printed.

The described examples show that printing inks have to meet a large number of requirements. The principal constituents of a printing ink are pigments, binders, solvents and additives with which the required properties of the printing inks are modified. Depending on the application envisaged for the printing ink, its viscosity, flow behavior and tack, for example, can be adjusted in this way.

The various requirements which the physical properties are expected to meet, particularly in the case of large-run printed products, impose stringent demands on the solvent used in the printing ink. On the one hand, it must be able to dissolve or disperse various binders (resins) and various additives; on the other hand, it should enable the viscosity of the printing ink to be adjusted to the required range.

In the past, mineral oils were originally used to a large extent as solvents for printing inks, mainly on cost grounds. This was unsatisfactory for a number of reasons so that there has long been a need to use mineral oil substitutes as solvents for printing inks. For about a decade now, certain fatty acid esters have often been proposed as solvents for printing inks. However, there is still a permanent demand for new developments in this field.

WO-A-90/03419 (Aarhus Oliefabrik) describes the use of C₁₋₅ esters of aliphatic C₈₋₂₂ monocarboxylic acids for removing grease, inks and other soils from printing machines.

JP-B2-3,317,512 (Nisshin Oil Mills) describes solvents for planographic and letterpress printing inks which contain as their principal constituent fatty acid monoesters of which the fatty acid component contains 6 to 22 carbon atoms and the alcohol component 1 to 4 carbon atoms.

U.S. Pat. No. 5,104,567 (A/S Alaska Gruppen) describes cleaning fluids for removing printing inks from printing machines, these cleaning fluids containing a vegetable oil and an emulsifier in the form of a surfactant.

WO-A-96/34920 (Henkel KGaA) describes solvent compositions for printing inks. The compositions contain (a) dearomaticized mineral oils, (b) esters of C₈₋₂₂ fatty acids and/or (c) C₆₋₃₆ fatty alcohols.

U.S. Pat. No. 4,357,164 (Sakata Shokai Ltd.) describes printing ink compositions containing high-boiling solvents in combination with esters based on C₄₋₁₀ fatty acids, oleic acid and elaidic acid.

U.S. Pat. No. 5,122,188 (The United States of America) describes printing inks based on heat-treated oils, the heat treatment leading to polymerization products with a molecular weight above 26,000.

U.S. Pat. No. 5,340,493 (R. J. Principato) describes cleaning compositions for removing printing inks from machine parts used in the printing industry. The ternary compositions contain esters of tall oil fatty acids, organic solvents and surfactants.

U.S. Pat. No. 5,178,672 (Canadian Fine Color Company) describes a carrier medium for paste-form printing inks, this carrier medium containing esters based on vegetable fatty acids and simple alcohols or glycols as solvent. The vegetable fatty acids are understood to be those which occur naturally in oils of vegetable origin, i.e. which have not been subjected to further chemical modification. The main representatives of the described class of fatty acids are mentioned in column 2, lines 32-37. They are saturated and olefinically unsaturated linear fatty acids.

U.S. Pat. No. 5,427,615 (Arizona Chemical Comp.) describes a process for the production of a gel-form printing ink composition, a fatty acid ester being used as solvent (step B). The fatty acid constituent of the ester comprises C₈₋₂₄ fatty acids while the alcohol constituent comprises alcohols or glycols containing 1 to 10 carbon atoms, with the proviso that the fatty acid emanates from oils which occur in linseed oil, soybean oil and rapeseed oil.

U.S. Pat. No. 5,173,113 (Topez Comp.) describes printing ink compositions which contain di- or oligoesters of olefinically unsaturated fatty acids and di- or polyfunctional acrylate esters as functional constituents.

U.S. Pat. No. 5,713,990 (The United States of America) describes printing ink compositions based on a ternary mixture: (1) a resin or heat-treated (and hence polymerized) oil, (2) a non-heat-treated vegetable oil and (3) at least one fatty acid ester based on unsaturated fatty acids, more particularly linoleic acid and linolenic acid. Component (3) is present in minor amounts.

### DESCRIPTION OF THE INVENTION

As the expert is aware, solvents perform various functions in printing inks. First of all, they dissolve or disperse the main components of the printing ink, more especially pigments and binders (resins). At the same time, they guarantee the transport of the printing ink from the reservoir onto the printing rollers and the substrate to be printed. In this connection, the solvents have sometimes also been referred to by experts as carrier media or carrier oils for printing inks, cf. Welt der Farben, No. 5/1997, pages 11-18. Wherever the expression “solvents for printing inks” is used in the present specification in line with common terminology, it is intended to encompass the alternative names.

The present invention relates to the use of fatty acid esters as solvents for printing inks, the fatty acid constituents of the esters being saturated and/or mono- or polyolefinically unsaturated fatty acids containing a total of 12 to 22 carbon atoms and the alcohol constituents of the esters being saturated and/or mono- or polyolefinically unsaturated monoalcohols containing a total of 1 to 22 carbon atoms, with the additional proviso that the fatty acid constituents of the esters contain an aryl group which may optionally be substituted by an aliphatic group.

According to the invention, esters that are liquid at 20° C. are preferred solvents.

Fatty Acid Constituents of the Esters

As mentioned above, esters based on fatty acids containing aromatic structural elements are understood to be esters of which the fatty acid constituents are saturated and/or mono- or polyolefinically unsaturated fatty acids containing a total of 1 to 22 carbon atoms and of which the alcohol constituents are saturated and/or mono- or polyolefinically unsaturated monoalcohols containing a total of 1 to 22 carbon atoms, with the additional proviso that the fatty acid constituents of the esters contain an aryl group which may optionally be substituted by an aliphatic group. The aryl group (as a substituent) may basically be positioned anywhere in the fatty acid chain. The aryl group is preferably a phenyl group. If the aryl group is substituted, the substituent is preferably an alkyl substituent, more particularly a saturated, linear or branched alkyl group containing a total of 1 to 8 carbon atoms.

Alcohol Constituents of the Esters

Preferred alcohol constituents of the esters are saturated monoalcohols containing a total of 1 to 12 carbon atoms. They may be saturated or unsaturated, linear or branched. Methanol, ethanol, n-propanol, isopropanol, n-butanol, isobutanol and 2-ethylhexanol are most particularly suitable alcohol constituents of the esters.

Other Embodiments

In one embodiment, the esters mentioned based on fatty acids containing aromatic structural elements are used in combination with
esters based on linear fatty acids,
esters based on fatty acids containing alicyclic structural elements and
esters based on fatty acids containing branched fatty acids.

According to this embodiment, the present invention also relates to the use of compositions containing
esters based on linear fatty acids,
esters based on branched fatty acids,
esters based on fatty acids containing alicyclic structural elements and
esters based on fatty acids containing aromatic structural elements as solvents for printing inks.

The compositions mentioned are preferably used in the form of the esters of so-called monomer fatty acids. These are commercially obtainable products, for example Emery® 935 (formerly: Aliphat® 47), a product of the applicant. The production of monomer fatty acids is described in the section entitled “monomer fatty acids”.

The following observations apply to the above-mentioned components of the composition:
Esters based on linear fatty acids are understood to be esters of which the fatty acid constituents contain a total of 12 to 22 carbon atoms and of which the alcohol constituents are saturated and/or mono- or polyolefinically unsaturated monoalcohols containing a total of 1 to 22 carbon atoms, with the additional proviso that the fatty acid constituents of the esters are linear and aliphatic. Within this class of compounds, stearic acid esters are particularly preferred.
Esters based on branched fatty acids are understood to be esters of which the fatty acid constituents are fatty acids containing a total of 12 to 22 carbon atoms and of which the alcohol constituents are saturated and/or mono- or polyolefinically unsaturated mono-alcohols containing a total of 1 to 22 carbon atoms, with the additional proviso that the fatty acid constituents of the esters are saturated and/or mono- or polyolefinically unsaturated fatty acids and have a branched structure. Iso-oleic acid is preferred as the fatty acid constituent.
Esters based on fatty acids containing alicyclic structural elements are understood to be esters of which the fatty acid constituents contain a total of 12 to 22 carbon atoms and of which the alcohol constituents are saturated and/or mono- or polyolefinically unsaturated monoalcohols containing a total of 1 to 22 carbon atoms, with the additional proviso that the fatty acid constituents of the esters contain an alicyclic group, preferably a cyclohexyl group, which may optionally be substituted by an aliphatic group. If the alicyclic group is substituted, the substituent is preferably an alkyl substituent, more particularly a saturated, linear or branched alkyl group containing a total of 1 to 8 carbon atoms.
Esters based on fatty acids containing aromatic structural elements are understood to be esters of which the fatty acid constituents are saturated and/or mono- or polyolefinically unsaturated fatty acids containing a total of 12 to 22 carbon atoms and of which the alcohol constituents are saturated and/or mono- or polyolefinically unsaturated monoalcohols containing a total of 1 to 22 carbon atoms, with the additional proviso that the fatty acid constituents of the esters contain an aryl group which may optionally be substituted by an aliphatic group. The aryl group (as a substituent) may basically be positioned anywhere in the fatty acid chain. The aryl group is preferably a phenyl group. If the aryl group is substituted, the substituent is preferably an alkyl substituent, more particularly a saturated, linear or branched alkyl group containing a total of 1 to 8 carbon atoms.
   Monomer Fatty Acid

As the expert is aware, dimer fatty acids are carboxylic acids obtainable by oligomerization of unsaturated carboxylic acids, generally fatty acids, such as oleic acid, linoleic acid, erucic acid and the like. The oligomerization is normally carried out at elevated temperature in the presence of a catalyst, for example of clay. The substances obtained—technical-quality dimer fatty acids—are mixtures in which the dimerization products predominate. However, the mixtures also contain small amounts of monomers (the sum total of monomers in the crude mixture of the dimer fatty acids is referred to by the expert as monomer fatty acids) and higher oligomers, more especially the so-called trimer fatty acids. Dimer fatty acids are commercially available products and are available in various compositions and qualities (for example under the name of Empol®, a product of the applicant).

As already mentioned, the monomeric compounds present in the mixture for the production of dimer fatty acids after the reaction has been carried out and obtainable therefrom by distillation-based processes are normally referred to by the expert as monomer fatty acids. In this connection, it is pointed out that the expression “monomer fatty acids” is known to the expert, cf. for example the paragraph bridging pages 770 and 771 in the chapter “Dimer Acids” of the reference book Kirk-Othmer, Encyclopedia of Chemical Technology, 3rd Edition, Vol. 7 (1979).

The monomer fatty acids are not unreacted starting material of the process for producing dimer fatty acids, but rather products of a secondary reaction containing small amounts of unreacted starting material. The secondary reaction leads to a structural modification of the fatty acids used.

The composition of the monomer fatty acids is subject to certain variations in regard to the nature of the starting materials used in the production of the dimer fatty acids. For example, the content of compounds containing aromatic structural elements in the monomer fatty acids is particularly pronounced when linoleic acid is predominantly used as starting material.

Esters based on monomer fatty acids obtainable in the production of dimer fatty acids using either oleic acid or linoleic acid or a mixture of oleic and linoleic acid (for example in the form of the so-called tall oil fatty acids) as starting material are particularly preferred for the purposes of the present invention.

1. The use of fatty acid esters as solvents for printing inks, characterized in that the fatty acid constituents of the esters are saturated and/or mono- or polyolefinically unsaturated fatty acids containing a total of 12 to 22 carbon atoms and the alcohol constituents of the esters are saturated and/or mono- or polyolefinically unsaturated monoalcohols containing a total of 1 to 22 carbon atoms, with the additional proviso that the fatty acid constituents of the esters contain an aryl group which may optionally be substituted by an aliphatic group.

2. The use claimed in claim 1, characterized in that the aryl group is a phenyl group.

3. The use claimed in claim 2, characterized in that the phenyl group is substituted by a saturated, linear or branched alkyl group containing a total of 1 to 8 carbon atoms.

4. The use claimed in claim 1, characterized in that the alcohol constituents of the esters are saturated monoalcohols containing a total of 1 to 12 carbon atoms.
